(19) United States
(12) Patent Application Publication
(10) Pub. No.: US 2022/0284450 A1
(43) Pub. Date: Sep. 8, 2022

(54) SYSTEM AND METHOD FOR DETERMINING SENTIMENT INDEX FOR TRANSACTIONS

(71) Applicant: THE TORONTO-DOMINION BANK, TORONTO (CA)

(72) Inventors: SHAHRIAR ASTA, BRADFORD (CA); CHRISTOPHER JAMES ORLANDO, TORONTO (CA); ANGELA CHRISTINE HONG, TORONTO (CA); ANGELA P. REID, TORONTO (CA); STEPHEN LEUNG, TORONTO (CA); JENNY SALAZAR, TORONTO (CA); JEFFREY LEE BECK, TORONTO (CA); MUSA KAJEE, TORONTO (CA); LYNN SUDERMAN, TORONTO (CA)

(21) Appl. No.: 17/191,433

(22) Filed: Mar. 3, 2021

(51) Int. Cl. G06Q 30/02; G06Q 40/04

(52) U.S. Cl. CPC G06Q 30/0201; G06Q 40/04

(57) ABSTRACT

A computing device is configured for determining a sentiment index for display on a user interface of a destination computing device. The computing device tracks and receives real-time actual transaction activity information detailing each transaction performed over a past time period for each user from a plurality of users associated with an entity. Then, a set of proxy components are determined to represent the transaction activity information based on types of transactions in the transaction activity information. The sentiment index is generated having a value representing market sentiment for confidence at a current time in performing transactions based on a weighted sum and/or difference of the set of proxy components and display the value of the sentiment index on an interactive display of the user interface for subsequent use in performing further transactions.

### FIELD

The present disclosure relates to a system and method for analyzing actual transaction behavior trends in determining a sentiment index for the transactions.

### BACKGROUND

One of the issues faced in online banking solutions is how to better utilize the large amounts of investment data being transacted in a useful way such as to gain insights from the data and to engage potential investors in a way to cause them to better interact with the online banking solutions. The financial institutions may have a high proportion of disengaged or inactive investment clients who may not feel confident in performing online investment transactions and/or overwhelmed with the investment choices available. There is a need to stimulate client interest and engagement with the online banking solutions, while better utilizing the large amounts of data to gain insights on investing trends in retail market sentiment in an accurate and efficient manner.

Currently there exists a need to transform large amounts of transaction and trading data into relevant, engaging, and actionable insight.

Globally, sentiment indications are not based on actual trade level data and are unable to deal with complexities of such large data. There is a need to uncover true levels of sentiment and the risk tolerance of investors.

There is thus a need for a system and method for automatically and dynamically generating a sentiment index indicative of current and future trends for performing online transactions based on real-time transaction information.

### SUMMARY

In at least some implementations, there is provided a computer device and method which allows transforming big data from investment transactions with a financial entity into relevant, engaging and actionable insights to be presented on a client user interface (e.g. a banking software application for the entity) to stimulate engagement with the user interface and entice investment transactions.

The method includes tracking of actual trading data for each retail investor to gain insight into user behaviour to determine an investor sentiment index based on the actual trades placed by clients. The sentiment index provides a quantification of investor optimism/pessimism of trading over time. The method differs from existing techniques at least by using actual ‘hard’ trading data behaviour (e.g. buy/sell/put/call, etc.) of each individual retail investor to reveal a true sentiment proxy.

In at least some implementations, the proposed solution includes a computer method which allows tracking of actual trading data for retail investor to gain insight and determine an investor sentiment index based on the actual trades placed by clients. The sentiment index provides a quantification of investor optimism/pessimism over time. The disclosed method automatically uses actual ‘hard’ trading data activity (e.g. buy/sell/put/call, etc.) of each individual retail investor to reveal a true sentiment proxy as displayed on an interactive interface.

Existing sentiment indications are inaccurate and erroneous and are unable to uncover true sentiment indices in predicting online transaction behaviour.

According to an aspect of the present disclosure there is provided a computing device for determining a sentiment index for a plurality of transactions, the computing device comprising a processor, a storage device, and a communication device where each of the storage device and the communication device is coupled to the processor, the storage device storing instructions, which when executed by the processor, configure the computing device to: track and receive real-time actual transaction activity information detailing each transaction performed over a past time period to a current time for each user from a plurality of users associated with an entity; determine a set of proxy components to represent the transaction activity information based on types of the transactions in the transaction activity information; generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and communicate the value of the sentiment index to a destination computing device for display on an interactive display of a user interface for subsequent use in performing further transactions.

According to another aspect, there is provided a computer implemented method for determining a sentiment index for a plurality of transactions, the method comprising: track and receive real-time actual transaction activity information detailing each transaction performed over a past time period to a current time for each user from a plurality of users associated with an entity; determine a set of proxy components to represent the transaction activity information based on types of the transactions in the transaction activity information; generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and communicate the value of the sentiment index to a destination client computing device for display on an interactive display of a user interface for subsequent use in performing further transactions.

According to yet another aspect, there is provided a computer program product comprising a non-transient storage device storing instructions that when executed by at least one processor of a computing device, configure the computing device for determining a sentiment index for a plurality of transactions, the computing device configured to: track and receive real-time actual transaction activity information detailing each transaction performed over a past time period to a current time for each user from a plurality of users associated with an entity; determine a set of proxy components to represent the transaction activity information based on types of the transactions in the transaction activity information; generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and communicate the value of the sentiment index to a destination computing device for display on an interactive display of a user interface for subsequent use in performing further transactions.

These and other aspects will be apparent to those of ordinary skill in the art.

### BRIEF DESCRIPTION OF THE DRAWINGS

These and other features of the disclosure will become more apparent from the following description in which reference is made to the appended drawings wherein:

FIG. 1 is a diagram illustrating an example computing device, behaviour processing server, communicating in a communication network and configured to generate and output for display to a destination computing device, e.g. a client computing device, a sentiment index characterizing transactions performed, in accordance with one or more aspects of the present disclosure.

FIG. 2 is a diagram illustrating an example behaviour processing server, in accordance with one or more aspects of the present disclosure.

FIG. 3A and FIG. 3B illustrate example operations of the behaviour processing server of FIGS. 1 and 2, including example graphical user interfaces or portions thereof presented by the behaviour processing server, in accordance with one or more aspects of the present disclosure.

FIGS. 4 and 5 are diagrams illustrating example graphical user interfaces and corresponding views of the client computing device shown in FIG. 1, in accordance with one or more aspects of the present disclosure.

FIG. 6 is a flowchart illustrating example operations of the behaviour processing server of FIG. 1, in accordance with one or more examples of the present disclosure.

### DETAILED DESCRIPTION

One or more currently preferred embodiments have been described by way of example. It will be apparent to persons skilled in the art that a number of variations and modifications can be made without departing from the scope of the invention as defined in the claims.

Generally, there is proposed a computerized method and system which transforms large amounts of actual real-time transaction information into dynamically generated actionable insights. Preferably, this utilizes a set of behavioural proxies (or metrics) to measure investor sentiment from actual client transaction data (e.g. trading data, account holding data, etc.). Further preferably, the input data utilizes actual transactions each investor makes (e.g. trade activity level and behavioural information). The set of proxies may be pre-defined and/or automatically selected via an automated process (e.g. principal component analysis and/or factor analysis). Further preferably, the system and method may be able to differentiate between individual investors and retail investor and determine a set of proxies accordingly based on the type of investors.

In at least some implementations, the set of proxies includes at least: net equity demand (NED), flight to safety (FTS), annual extremes (ANEX) and trade direction (DIR). NED defines: buy/sell imbalance and determines the net balance between buys and sells; DIR chases trends and quantifies how much investors are buying on advancing share prices; ANEX indicates buying at top vs dip and determines if investors are buying at the top of the market or at the dip of the market; and FTS defines the risk appetite and provides a net difference between net investment in risky assets and safe assets.

In at least some aspects, principal component analysis is applied by the method to the transaction information of all investors being monitored based on the set of proxies to determine coefficients for each of the proxy components (e.g. may also be referred to as proxy variables or proxies herein). Principal component analysis (PCA) thus decomposes the entire proxy space to determine the coefficients for a best fit estimate of the equation for the sentiment. Preferably, the proxy variables with negligible size components are filtered or removed by the method. Based on applying the principal component analysis to the preferred proxies, a PCA model is thus used such that the sentiment is determined as a weighted sum/difference combination of the preferred proxies, e.g.:

Sentiment=0.30×DIR+0.38×NED+0.47×ANEX−0.62×FTS

The above sentiment is based on a particular set of data and may thus have differing coefficients and proxies for other data.

The sentiment index value may indicate market trend, e.g. bearish/bullish for all clients in entire space of all transaction date (e.g. equities) which were examined based on the transaction data for each investor and associated transaction.

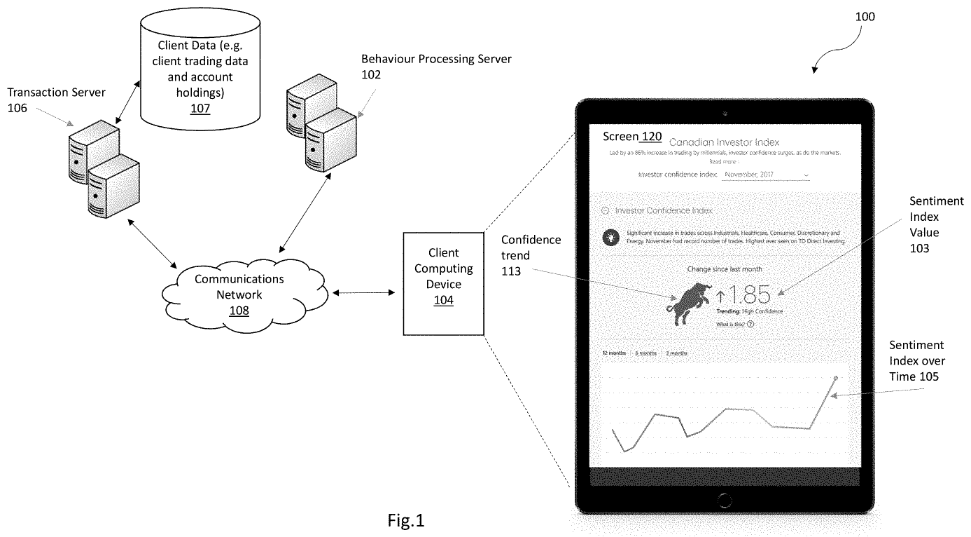

Preferably, the sentiment index value is provided on an interactive user interface to each relevant user as shown in FIG. 1 (e.g. see an example sentiment index as “investor confidence index” in sentiment index value 103). This provides an indication to users of how retail investors are behaving and in one example, may entice novice or dormant investors to interact with the user interface of the receiving device for requesting additional data and/or implementing trades via the user interface. The sentiment index may further be shown on the user interface over a period of time as an indication of the trend of the investor confidence (see sentiment index over time 105, also known as a sentiment time series).

Preferably, the sentiment index measures the sentiment of specific types of users, e.g. long term average investors (LTAI) and the proxies are further defined based on pre-defined variables only applicable to the specific types of users, e.g. LTAI investors.

FIG. 1 is a diagram illustrating an example computer network 100 in which a computing device, e.g. a behaviour processing server 102 is configured to communicate with one or more other computing devices, including a transaction server 106 having an associated database of client data 107 (e.g. client trading data and accounting holdings), and one or more client computing device(s) 104 using a communications network 108. It will be understood that although a single client computing device 104 has been illustrated for simplicity in FIG. 1, a number of client computing devices 104 for communicating with the computing systems of network 100 and receiving sentiment information for display on corresponding user interfaces, may be envisaged.

Transaction server 106 is configured to provide client data 107 (e.g. reflective of actual trades placed including client trading data, account holdings and/or account identification information) from its storage device(s) to behaviour processing server 102 via the communications network 108 for subsequent processing. The transaction server 106 comprises at least a processor, data stores comprising storage devices, as well as a communication device for communicating information with computing systems depicted in FIG. 1.

The behaviour processing server 102 is configured to receive actual trading client trading data activity of each user for all users associated with an entity of interest, via client data 107. The client data 107 reflects actual transactions each investor has made (e.g. trade activity level and behavioural information) and thus reflects actual transaction behaviour of users. For example, the client data 107 may include database records for every transaction (e.g. buy/sell) a corresponding user has conducted.

In turn, the behaviour processing server 102 is configured to analyze the client data 107 and determine a confidence metric for performing transactions via a sentiment index which automatically and dynamically characterizes the behaviour of users in the client data 107 and provides insights on the future trends of the behaviour (e.g. users are depicting a high confidence level for investments and likely to continue with online transactions). Thus, the behaviour processing server 102 utilizes actual ‘hard’ trading data of investors to reveal an accurate and effective sentiment proxy. The behaviour processing server 102 provides the indication of the sentiment, to one or more client computing device(s) 104 for display on their corresponding interactive user interfaces for subsequent interaction therewith. As shown in FIG. 1, the client computing device 104 may receive for display on a screen 120, a current sentiment index value 103 (e.g. a value of the current sentiment based on a set of proxy variables which characterize the client data 107 behaviour derived from machine learning modelling performed by the behaviour processing server 102) and correspondingly displayed is a sentiment index over time 105 which illustrates a graph of the sentiment index in a past time period (e.g. last 12 months) thereby providing a true measure of the investor confidence index currently and in the past. In at least some aspects, the screen 120 may also receive from the behaviour processing server 102, an indication of a trend for investor sentiment based on historical data and predictive modelling performed by the behaviour processing server 102. Thus, the screen 120 may display an indicator of a confidence trend 113 based on a current value for the sentiment index value 103, the values of the sentiment index over time 105 and based on predicting a future trend direction (e.g. bearish or bullish) for the sentiment.

In the example of FIG. 1, client computing device 104 is a mobile phone. Other examples of client computing device 104 may be a tablet computer, a personal digital assistant (PDA), a laptop computer, a tabletop computer, a portable gaming device, a portable media player, an e-book reader, a watch, or another type of computing device. In the example of FIG. 1, transaction server 106 and behaviour processing server 102 are servers. Each of these is an example of a computing device having at least one processing device (e.g. a processor, etc.) and memory (e.g. a storage device, etc.) storing instructions which when executed by the processing device configure the computing device to perform operations as described in the present disclosure.

Client computing device 104, behaviour processing server 102, and transaction server 106 are coupled for communication to communication network 108 which may comprise a wide area network (WAN) such as the Internet. Communication network 108 is coupled for communication with a plurality of computing devices. It is understood that communication network 108 is simplified for illustrative purposes. Communication network 108 may comprise additional networks coupled to the WAN such as a wireless network and/or local area network (LAN) between the WAN and client computing device 104 (not shown), etc.

Client computing device 104 may generate output for display on the screen 120 of a graphical user interface in response to operation of the behaviour processing server 102 and/or transaction server 106. The output of the client computing device 104 may be displayed on other types of screen such as a projector, a monitor, or other display device. It will be understood that the user interface may also operate as an input/output device and may be configured using a variety of technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

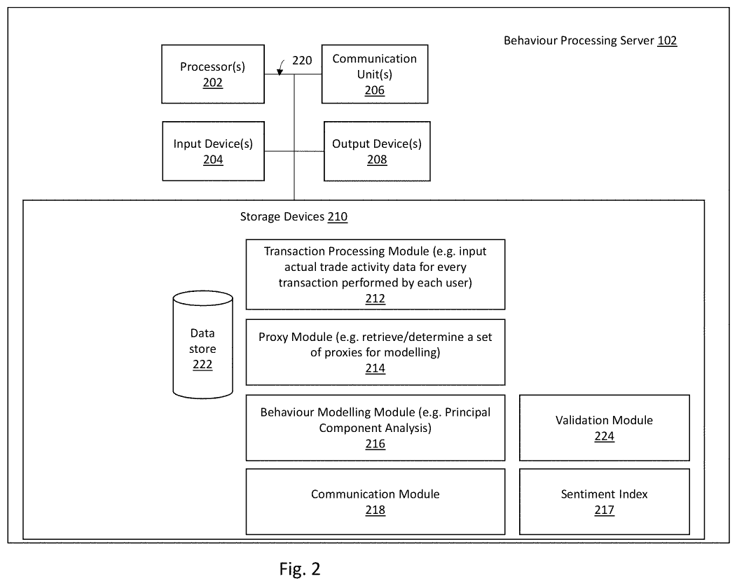

Referring to FIG. 2, shown is a diagram illustrating in block schematic form an example computing device (e.g. behaviour processing server 102 shown in FIG. 1), in accordance with one or more aspects of the present disclosure, for example to provide a system to understand online transaction behaviour for users related to actual transactions performed and to determine, therefrom, a sentiment index reflective of the transaction behaviour for display on a user interface of one or more client computing devices 104. For example, such client computing device 104 may be subscribed or otherwise registered with the behaviour processing server 102 for receiving such updates relating to real time sentiment information.

Behaviour processing server 102 comprises one or more processors 202, one or more input devices 204, one or more communication units 206 and one or more output devices 208. Behaviour processing server 102 also includes one or more storage devices 210 storing one or more modules, including transaction processing module 212, a proxy module 214, a behaviour modelling module 216 for generating at least one sentiment index 217, a communication module 218, and a validation module 224. The storage devices 210 may also include one or more data stores 222, which may store transaction activity data such as client trading data for every transaction performed for each user associated with an entity, such as a financial institution. The data store 222 may further store a set of pre-defined set of proxy components, which are metrics for characterizing the sentiment of investors for performing transactions. The data store 222 may additionally store information about past proxy components used to describe specific transaction types. Such information may be accessed by the proxy module 214 to determine a set of proxy components for optimal use in behaviour modelling via the behaviour modelling module 216.

Communication channels 220 may couple each of the components including processor(s) 202, input device(s) 204, communication unit(s) 206, output device(s) 208, the storage device(s) 210, the transaction processing module 212, the proxy module 214, the behaviour modelling module 216 for generating at least one sentiment index 217, the communication module 218, and the validation module 224 for inter-component communications, whether communicatively, physically and/or operatively. In some examples, communication channels 220 may include a system bus, a network connection, an inter-process communication data structure, or any other method for communicating data.

One or more processors 202 may implement functionality and/or execute instructions within behaviour processing server 102. For example, processors 202 may be configured to receive instructions and/or data from storage devices 210 to execute the functionality of the modules shown in FIG. 2, among others (e.g. operating system, applications, etc.). Behaviour processing server 102 may store data/information to storage devices 210. Some of the functionality is described further herein below.

One or more communication units 206 may communicate with external devices (e.g. behaviour processing server 102 and/or transaction server 106) via one or more networks (e.g. communications network 108) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 220).

The one or more storage devices 210 may store instructions and/or data for processing during operation of behaviour processing server 102. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Transaction processing module 212 may be configured to collect and analyze actual transaction activity information detailing each transaction performed over a past time period up to the current time for each user of all users having accounts with an entity. For example, the transaction activity information may be received via the transaction server 106 and client data 107. The transaction activity information may include client trading data and account holdings collected over a time duration, this may include records for every transaction (e.g. buy/sell) performed by a user. Transaction processing module 212 may for example, also be configured to characterize the transaction activity information such as to determine the types of transactions performed in the transaction activity information received (e.g. specific securities types transacted) and types of account holders (e.g. retail investors and institutional investors). This characterization may be used for example by the proxy module 214 to determine one or more proxy components that have historically been used to classify the sentiment behaviour of prior transaction activity information having similar characterization to the current transaction activity information.

Transaction processing module 212 may cooperate with data store 222 to retrieve transaction activity information (e.g. received from transaction server 106) and further with proxy module 214, which determines one or more proxies that best characterize the sentiment metrics, and with behaviour modelling module 216 which applies the proxies to determine proxy coefficients or weighting to determine a sentiment index 217. The sentiment index 217 is preferably a linear combination of the proxy components, each having a corresponding weighting defined by the behaviour modelling module 216. Communication module 218 may further cooperate with behaviour modelling module 216 to determine information from the sentiment index 217 to communicate with one or more other computing devices such as client devices subscribed for receiving sentiment index updates. The validation module 224 may also cooperate with the behaviour modelling module 216 to determine whether the proxy components determined by the behaviour modelling module 216 are optimal (e.g. minimize the error for characterizing the transaction activity information).

Proxy module 214 may receive and/or determine and/or modify a set of proxy components to best characterize the transaction activity information.

The proxy components (also referred to as sentiment metrics) selected may preferably include at least: net equity demand (NED), flight to safety (FTS), annual extremes (ANEX) and trade direction (DIR). NED defines: buy/sell imbalance and determines the net balance between buys and sells; DIR chases trends and quantifies how much investors are buying on advancing share prices; ANEX indicates buying at top vs dip and determines if investors are buying at the top of the market or at the dip of the market; and FTS defines the risk appetite and provides a net difference between net investment in risky assets and safe assets. Preferably, the proxy components capture a greed indicator, a fear indicator, a demand indicator, and a herding indicator of the overall investor sentiment (e.g. optimism or pessimism) in performing transactions.

For example, if investors are buying more than selling, the value of the NED proxy component will be positive and indicating a high sentiment. In one example, if the DIR proxy component is positive, it indicates a lot of trades are being placed on increasing share prices which indicates greed and high sentiment. In another example, for the ANEX proxy component, the tendency to buy a security at its annually high price is a reflection of a positive sentiment. In yet another example, the FTS proxy component indicates that at times of low sentiment, larger migration from risk to safe assets is expected.

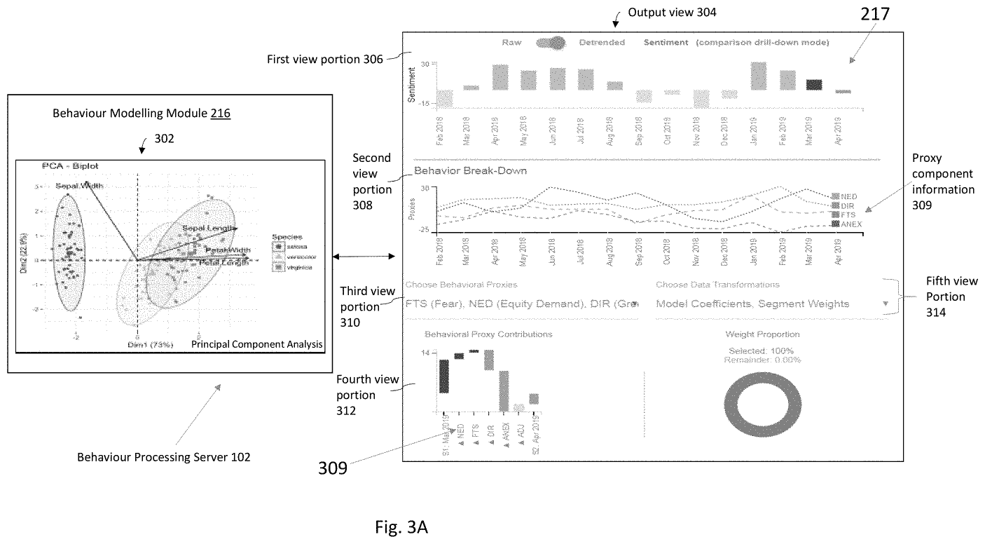

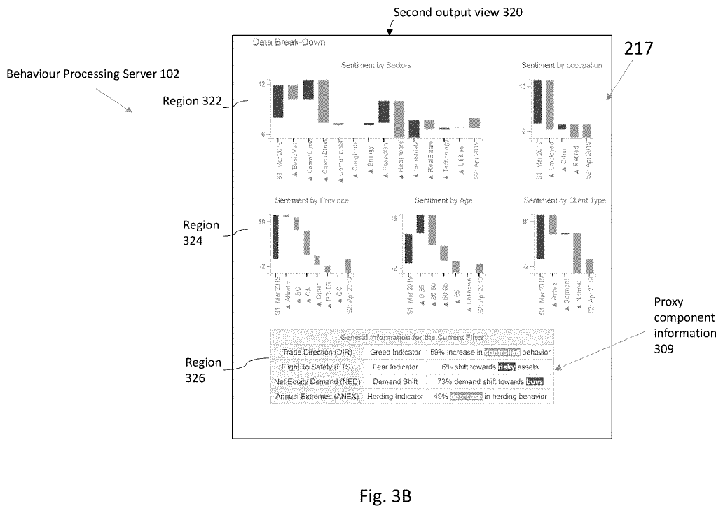

In at least some implementations, one or more of the following proxy components (e.g. see example proxy component information 309 in FIG. 3A) may be used by the behaviour processing server 102: investor surveys (questionnaires filled by a sample of investor population); volatility (price variance of shares traded by investors); put/call ratio (ratio between put and call options placed by investors); flight to safety (the net difference between equity and safe assets); buy/sell ratio (the ratio of buy orders to sell orders); new account openings (the number of new trading accounts in a time window); short/long ratio (ratio between short and long investment positions); trade direction (proportion of trades on shares with a positive price direction); return on positions (average return on assets held by investors over a time window); margin loan values (average margin loan taken by investors); in/out fund transfers (volume transferred in and out of funds); mutual fund flows (allocation across fund categories); annual extremes (ratio of share bought in their annual highs vs annual lows); trading volume; dividend premium; IPO first day returns; IPO volume; equity issues over total issues; closed end fund discount; overconfidence; small stock returns; options trajectory; buy sell imbalance; equity cash flow; equity cash flow; and value weighted discount.

As discussed above, the proxy module 214 may be configured to access a pool of available proxy components (e.g. stored on data store 222) and customize the set of proxy components for characterizing investor sentiment based on determining via, the transaction processing module 212 that the current set of transactions (e.g. second set of transaction) for review have certain characteristics (e.g. specific types of securities, specific types of investors, specific types of transaction purchases or sell made, etc.) similar to a prior set of transactions (e.g. a first set of transactions) having been associated with a first set of proxy components and thus modifies the set of proxy components to match with the first set of proxy components. Alternatively or additionally, machine learning classification algorithms may be applied to classify the two sets of transactions as similar to one another for determining the current set of proxy components. Furthermore, the proxy module 214 may be configured to automatically select a subset of proxy components from the available pool based on certain proxy components being previously associated as being better suited for certain populations (e.g. long term average investors (LTAI) or professional trader).

Thus, using machine learning classification algorithms, one or more of the proxy components available may be eliminated as irrelevant by the proxy module 214 based on a particular investor population revealed in the current transaction activity information. Further, the proxy module 214 may further reduce the set of proxy components based on a pre-defined frequency selected for the sentiment index 217. For example, if based on user input and/or feedback from client computing device 104, the sentiment index 217 is to be reported at a given frequency then the proxy module 214 is configured to further select the proxy components based on the given frequency. That is, in the case of daily sentiment index requirement, the proxy module 214 may discard certain proxy components that are unable to provide a timely response.

In at least some aspects, referring to FIGS. 1, 2 and 3A, the proxy module 214 may also present the set of determined proxy components (e.g. which may be determined via historical data) on a user interface of the behaviour processing server 102 (e.g. see view 304 in FIG. 3A which presents a set of behavioural proxies on a portion of the view, such as output view 304) and receive input from a user of the behaviour processing server 102 to further select the desired proxy components from a presented set.

Behaviour modelling module 216 may be configured to apply modelling analysis to determine a weighting or coefficients to characterize contribution of each proxy component to the resulting sentiment index calculated such as to optimally characterize the transaction activity information. Preferably, such modelling involves principal component analysis (PCA) applied to the proxy components provided by the proxy module 214 to determine a corresponding weighting or coefficient for each of the proxy components (also referred to as sentiment metrics) to determine the sentiment index 217 as a linear function of the selected proxy components and corresponding weightings. The PCA model used by the behaviour modelling module 216 may be trained on prior transaction activity information (e.g. from a prior time to a current time) such as to determine optimal weighting for each of the selected proxy components. In some implementation, the behaviour modelling module 216 may use factor analysis (FA) for determining the sentiment index and corresponding weightings.

Thus, in at least some implementations, the behaviour modelling module 216 applies principal component analysis to the transaction information of all investors being monitored based on a selected set of proxy components (e.g. as provided by the proxy module 214) to determine coefficients for each of the proxy components (e.g. may also be referred to as proxy variables herein). Principal component analysis (PCA) applied by the behaviour modelling module 216 thus decomposes the entire proxy space (e.g. transaction activity information provided by the transaction processing module 212) to determine coefficients for each of the proxy components for a best fit estimate of the model for calculating the sentiment index. Preferably, the behaviour modelling module 216 is configured to eliminate or discard the proxy components or variables with negligible size coefficients (e.g. coefficient values below a threshold).

Based on applying the principal component analysis (PCA) via the behaviour modelling module 216 to the preferred set of selected proxies provided from the proxy module 214, a PCA model is thus used such that the sentiment is determined as a weighted sum/difference combination of the preferred proxies. Thus, where the proxy module 214 has determined that the proxy components are preferably defined as net equity demand (NED); Flight to safety (FTS); Annual extremes (ANEX); and trade direction (DIR) then in at least some implementations, the sentiment index 217 model may be determined as:

Sentiment=a×(DIR)+b×(NED)+c×(ANEX)−d×(FTS)=0.30×DIR+0.38×NED+0.47×ANEX−0.62×FTS

Wherein in the above example, the variables a, b, c and d represent the proxy component coefficients providing the behavioral proxy contributions as calculated by the PCA model of the behaviour modelling module 216.

As may be envisaged, the above sentiment model is based on a particular set of transaction data (e.g. client trading data and account holdings) and may thus have differing coefficients and proxies for other data.

The sentiment index 217 (which may be expressed by way of example as a current sentiment index value 103 shown in FIG. 1 and over a time period as sentiment index over time 105) may indicate market trend, e.g. bearish/bullish for all clients in entire space of all transaction data (e.g. equities) which were examined based on the transaction data for each investor and associated transaction.

In at least some implementations, the communication module 218 is configured to receive sentiment index 217 information from the behaviour modelling module 216 and configured to communicate this information for further manipulation via a user interface of the behaviour processing server 102 (e.g. as shown in FIGS. 3A and 3B) and/or provide the sentiment index to one or more client computing devices 104 (e.g. as shown on screen 120 of FIG. 1).

Preferably, communication module 218 provides the sentiment index 217 value on an interactive user interface to each relevant user as shown in FIG. 1 (e.g. see FIG. 1 showing an example sentiment index as “investor confidence index” in sentiment index value 103). This provides an indication to users of how investors are behaving and in one example, may entice certain users, e.g. novice or dormant investors to interact with the user interface for additional transactions, such as to request additional data relating to the sentiment index 217 and/or implementing trades. The communication module 218 may further communicate the sentiment index 217 such that the sentiment index 217 may further be shown on the user interface (e.g. screen 120) over a period of time as an indication of the trend of the investor confidence (see sentiment index over time 105).

Preferably, the sentiment index 217 provided by the behaviour modelling module 216 measures a confidence sentiment of specific types of users, e.g. long term average investors (LTAI) and the proxies are further defined based on pre-defined variables only applicable to the specific types of users, e.g. LTAI investors.

Referring again to FIG. 2, the behaviour modelling module 216 may further cooperate with a validation module 224 configured to perform validation strategies and check the performance of the sentiment index 217. Thus, the sentiment index 217 may be validated by the validation module 224 using one or more of: causality test, in-sample performance vs out of sample performance, short term vs long term performance, count vs. volume vs. dollars. Once the validation is complete, the model for calculating the sentiment may be updated accordingly (e.g. sentiment may be updated to add new proxy variables, delete proxy variables or edit the coefficient values).

In at least one aspect, the causality test performed may be used to test if the sentiment time series is effective when forecasting returns and used to compare the sentiment index 217 with other sentiment indices as well as market returns. For example, a causality test may be applied to check effects of stock market on the sentiment and whether or not there is causality.

In at least one aspect, the in-sample performance versus out of sample performance compares the sentiment index 217 over time to determine the in-sample performance versus out of sample performance. This may also be applied when training the behaviour modelling module 216 such that data before a split point is used for training the PCA model and the resulting PCA model applied to data after the split point is reviewed to determine whether there exists significant shifts in trends or change.

In at least one aspect, short term versus long term performance (time horizon) is yet another validation criterion applied to determine how the model performs in various time horizons (e.g. both short and long term time horizon).

In at least one aspect, the effect of the volume/dollar amount of trades vs the number of trades is validated for calculating the sentiment index 217. For example, this may indicate to the transaction processing module 212 to filter out transactions for users responsible for more than a certain percentage of the total transactions performed before measuring the sentiment index 217.

It is understood that operations may not fall exactly within the modules 212, 214, 216, 218 and 224 of FIG. 2 such that one module may assist with the functionality of another.

Referring to FIG. 3A, shown is a diagram illustrating operation of components of the behaviour processing server 102, including the behaviour modelling module 216 generating an output for display on example graphical user interfaces as shown in output view 304, the output including a sentiment index 217 and proxy component information 309. Referring to FIG. 3A, the behaviour modelling module 216 applies, in at least some embodiments, principal component analysis modelling to generate a modelling output 302. The modelling output 302 illustrates a number of dimensions (e.g. proxy components) and determines an optimal weighting coefficient for each proxy component variable such as to generate the sentiment index as a linear combination of the proxy component variables and corresponding weighting coefficients that effectively and accurately depict the transaction activity information (e.g. provided by transaction processing module 212 of FIG. 2). The behaviour modelling module 216 thus may provide a number of outputs indicative of true levels of sentiment and risk tolerance of users based on actual trading data activity and corresponding behavioral proxy information shown as various view portions in output view 304. As shown in the output view 304, the sentiment index 217 may be display as broken down in segments over a certain time period to depict the trend thereof (e.g. see first view portion 306). The second view portion 308 breaks down the transaction activity information into various proxy components (e.g. NED, DIR, FTS, and ANEX) shown as proxy component information 309 and depicts breakdown of each proxy component activity over a given time period. A third view portion 310 illustrates a number of proxy components which were determined by the proxy module 214 for subsequent customization by a user, such that a user may further choose behavioural proxies from the proxy set displayed in third view portion 310. The fourth view portion 312 further display on the interactive display, the weighting coefficient for each proxy component shown as a set of behavioural proxy contributions.

Additionally, fifth view portion 314 further display a set of data transformations to customize via input from a user, such as model coefficients and segment weights. The sentiment index 217 shown as a function of time in the first view portion 306 is modified based on modifications made to customize the proxy components, their weighting and other modifications to the PCA model shown as modelling output 302.

Referring to FIG. 3B, shown is a second output view 320 of a graphical user interface provided by the behaviour processing server 102. The second output view 320 shows additional insight information provided by the behaviour processing server 102 (e.g. output of the behavioural modelling module of FIG. 2) regarding the sentiment values representing the sentiment index 217 as broken down into various categories and additional information relating to the proxy component information 309 corresponding to the sentiment for subsequent review and/or modification via the user interface. As shown, the behaviour processing server 102 enables generating sentiment index 217 information categorized by various common characteristics. For example, region 322 display the sentiment index 217 split up by sectors as well as occupation. Region 324 displays the sentiment index 217 split up by other sectors, such as province, age, and client type. Further, the behaviour processing server 102 may display additional proxy component information 309 which depicts effects of each proxy component on the overall sentiment (e.g. see region 326).

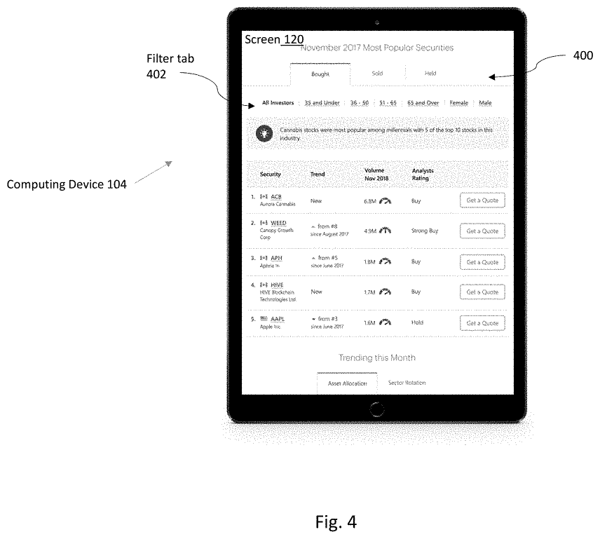

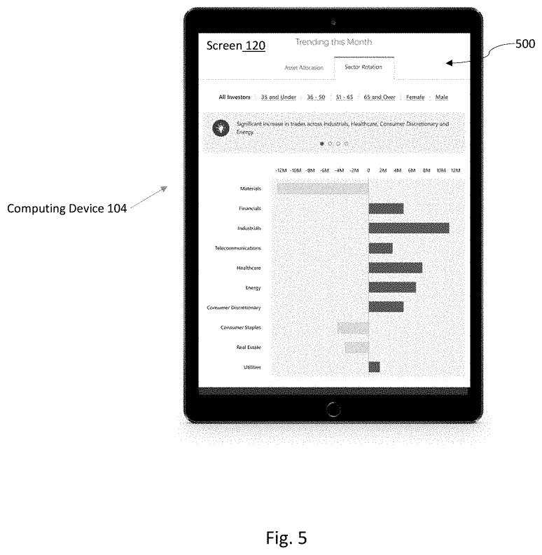

In one aspect, referring to FIGS. 4 and 5, the computing device 104 receiving the sentiment index information for display provides an interactive user interface shown as screen 120 having views 400 and 500 respectively where the sentiment index may be displayed and allows a user to filter the sentiment results to search for sentiment activity for specific types or groups of users such as investor clients (see filter tab 402 in FIG. 4). For example, the user may be able to filter to various dimensions by age, sector, geographic, trading types, etc. to see sentiment values updated (e.g. sentiment index value 103 and sentiment index over time 105 shown in FIG. 1 may be correspondingly updated to reflect filter selections). By selecting one of the dimensions, the sentiment index value 103 and/or sentiment index over time 105 is modified to tailor the proxy components (e.g. via the behaviour processing server 102) to those values within that dimension (e.g. include only sentiment analysis for all users aged 65 or older and within a specific geographic region). An example of the user interface filtering the sentiment by various dimensions is shown below in FIGS. 4 and 5.

Preferably, the user interface of the computing device 104 as shown in FIGS. 1, 4 and 5 by way of example, displays both the sentiment index (e.g. sentiment index value 103 and/or sentiment index over time 105) being broadcast to all client computing device 104 indicating market trend for investing along with an interactive interface for a user as shown in FIGS. 4 and 5 to drill down personalized information and view dimensions of the sentiment. That is, there is presented an interactive dashboard providing a sentiment filter, whereby the user can break down the sentiment information into dimensions, e.g. by age, sector, etc. and to view insights from that perspective (FIGS. 4 and 5).

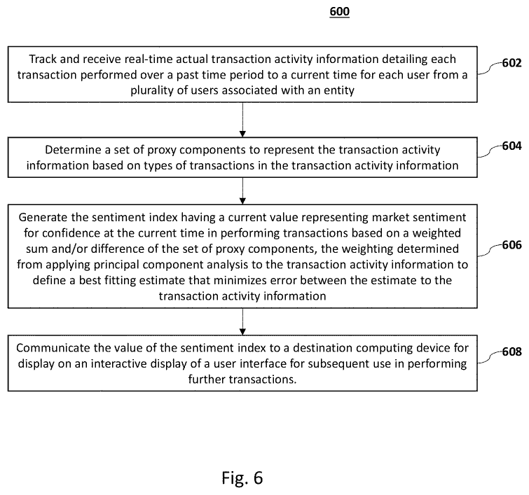

FIG. 6 is a flowchart of operations 600 performed by a computing device such as the behaviour processing server 102. The computing device comprises a processor configured to communicate with a display to provide a graphical user interface (GUI) where the computing device receives transaction input activity information reflective of trading data and account holdings and wherein instructions (stored in a non-transient storage device), which when executed by the processor, configure the computing device to perform operations such as operations 600 for determining real-time sentiment indication for predicting trends for future transactions.

Referring to FIGS. 1 and 6, at 602, operations of the behaviour processing server 102 track and receive real time actual transaction activity information (e.g. client trading data and account holdings) detailing each transaction performed over a past time period to a current time for each user form a plurality of users associated with an entity (e.g. users having accounts with the entity for performing transactions). As shown with reference to FIG. 1, such transactions may be continually monitored and received via the transaction server 106.

At 604, operations of the behaviour processing server 102, determine a set of proxy components to represent the transaction activity information based on types of transactions performed in the transaction activity information (e.g. a set of proxy variables which capture various behavioural dimensions of the transaction activity and thereby trends for the current transactions). The set of proxy components (e.g. net equity demand, may be automatically selected from a pool of available proxy components based on metadata characterizing the transactions such as the types of transactions performed in the transactions and/or types of users performing the transactions (e.g. retail investors vs institutional; dormant vs active investors, long term average investors or professional traders etc.). For example, based on historical analysis data, the metadata characterizing the transactions is used to determine appropriate proxy components. Notably, based on historical behaviours, certain types of transactions and/or types of users are mapped to selected proxy components. Thus, in at least some aspects, machine learning classification methods may be used to determine the set of proxy components by classifying the current transaction activity information as similar to a prior set of transaction activity information having a corresponding set of proxy components to characterize the behaviour of same.

Preferably, the set of proxy components includes at least: net equity demand (NED), flight to safety (FTS), annual extremes (ANEX) and trade direction (DIR). NED defines: buy/sell imbalance and determines the net balance between buys and sells; DIR chases trends and quantifies how much investors are buying on advancing share prices; ANEX indicates buying at top vs dip and determines if investors are buying at the top of the market or at the dip of the market; and FTS defines the risk appetite and provides a net difference between net investment in risky assets and safe assets.

In at least some implementations, the set of proxy components is selected from one or more of: volatility of shares traded by investors, the ratio between put and call options, the ratio of buy orders to sell orders, the number of new trading accounts in a time window, the ratio between short and long investment positions, portion of trades on shares with a positive price direction, the average return on assets held by investors over a time window, the average margin loan taken by investors, the volume transferred in and out of funds, allocation across fund categories, ratio of share bough in annual highs vs annual lows.

Further preferably, the proxy components capture different aspects of user behaviour in performing transaction (e.g. fear, greed, herding, and demand).

At 606, operations of the behaviour processing server 102 generate the sentiment index as a function of time which characterizes the behaviour of the transaction activity information with reference to the various dimensions (e.g. proxy components) incorporated at different proportions (e.g. weighting coefficients for each of the proxy components). The sentiment index function has a current value for the current time representing market sentiment for confidence in performing transactions based on a weighted sum and/or difference (a linear combination) of the set of proxy components. Specifically, a weighting coefficient for each proxy component is determined from applying principal component analysis to the transaction activity information to determine a best fitting estimate (e.g. see fourth view portion 312 depicting behavioral proxy contributions) that minimizes error between the estimate to the transaction activity information. Simply put, principal component analysis (PCA) determines a particular weighting coefficient for each selected proxy component in the sentiment which is expressed as a weighted linear combination of the proxy components so that the sentiment best represents the transaction activity information. That is, PCA decomposes the proxy component space into factor and principal components, respectively. See for example modelling output 302 shown in FIG. 3A. Here, the proxy components represent investor behaviours and the variance reveals fluctuations in investor behaviour used to reveal the change in sentiment.

The PCA model may be previously trained on the proxy components using prior historical training data of known historical activity information to determine the weighting coefficients for each of the proxy components. An example sentiment index may be expressed as Sentiment=0.30×DIR+0.38×NED+0.47×ANEX−0.62×FTS. In one aspect, when a current value of a sentiment index is positive, this may imply “bullish” and when a sentiment index is negative, this may imply “bearish”. As may be seen, each proxy component may have a different weighting coefficient determined by the PCA analysis to best capture the transaction activity information.

In at least some implementations, the sentiment value calculated for a current time is mapped such that it is between a first value (fixed floor) and a second value (ceiling). In this way, different sentiment values (e.g. sentiment index value 103) presented on a user interface may be interpreted in such a way as to be easily compared with other sentiment values.

In at least some implementations, one or more proxy components used to represent the sentiment index may be eliminated if their weighting coefficient is negligible (e.g. below a given threshold) subsequent to applying the principal component analysis.

At 608, operations of the behaviour processing server 102, communicate the value of the sentiment index to a destination computing device (e.g. client computing device 104) for display on an interactive display of a user interface for the client computing device for subsequent use in performing further transactions based on the sentiment index. See for example screen 120 of FIG. 1 depicting a display of the sentiment index (e.g. sentiment index value 103 showing a current value for the sentiment index, a confidence trend 113 indicator indicating whether the current trend is indicating bullish/bearish and the sentiment index over time 105).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the invention as defined in the claims.

What is claimed is:

1. A computing device for determining a sentiment index for a plurality of transactions, the computing device comprising a processor, a storage device, and a communication device where each of the storage device and the communication device is coupled to the processor, the storage device storing instructions, which when executed by the processor, configure the computing device to:
track and receive real-time actual transaction activity information detailing each transaction performed over a past time period to a current time for each user from a plurality of users associated with an entity;
determine a set of proxy components to represent the transaction activity information based on types of the transactions in the transaction activity information;
generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and
communicate the value of the sentiment index to a destination computing device for display on an interactive display of a user interface for subsequent use in performing further transactions.

2. The computing device of claim 1 wherein the set of proxy components is selected from: net equity demand (NED), flight to safety (FTS), annual extremes (ANEX), and trade direction (DIR).

3. The computing device of claim 2 wherein the interactive display of the destination computing device provides a filter tool displayed on the user interface to receive a request to filter the transaction activity information according to certain selected characteristics for the plurality of users, and thereby re-generate, via the computing device, a new value for the sentiment index based on the selected characteristics.

4. The computing device of claim 2 wherein the proxy components used to represent the sentiment index are eliminated if their weighting coefficient is negligible from applying the principal component analysis.

5. The computing device of claim 4 wherein the value of the sentiment index is calculated and communicated for display on the interactive display as a function of time from the past time period to the current time period.

6. The computing device of claim 5 wherein the sentiment index is based on a machine learning model of the weighted sum and/or difference of the set of proxy components and the machine learning model including the set of proxy components is modified dynamically based on the transaction activity information gathered at a subsequent time.

7. The computing device of claim 1 wherein the set of proxy components is selected from one or more of: volatility of shares traded by investors, a ratio between put and call options, a ratio of buy orders to sell orders, a number of new trading accounts in a time window, a ratio between short and long investment positions, portion of trades on shares with a positive price direction, an average return on assets held by investors over a time window, an average margin loan taken by investors, a volume transferred in and out of funds, allocation across fund categories, ratio of share bough in annual highs vs annual lows.

8. The computing device of claim 2, wherein a positive sentiment index indicates a bullish trend towards performing transactions and a negative sentiment index indicates a bearish trend towards performing transactions.

9. The computing device of claim 2, wherein the set of proxy components selected provide an indicator of greed, demand, fear and herding for characterizing the actual transaction activity information.

10. The computing device of claim 1, wherein determining the set of proxy components to represent the transaction activity information based on types of transactions in the transaction activity information further comprises classifying types of transactions as similar to prior types of transactions having associated set of proxy components used to evaluate a corresponding sentiment index.

11. The computing device of claim 1, wherein determining the set of proxy components further comprises determining one or more characteristics of users when performing the transactions and retrieving a corresponding set of proxy components previously associated with the characteristics of the users.

12. A computer implemented method for determining a sentiment index for a plurality of transactions, the method comprising:
track and receive real-time actual transaction activity information detailing each transaction performed over a past time period to a current time for each user from a plurality of users associated with an entity;
determine a set of proxy components to represent the transaction activity information based on types of the transactions in the transaction activity information;
generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and
communicate the value of the sentiment index to a destination client computing device for display on an interactive display of a user interface for subsequent use in performing further transactions.

13. The method of claim 12 wherein the set of proxy components is selected from: net equity demand (NED), flight to safety (FTS), annual extremes (ANEX), and trade direction (DIR).

14. The method of claim 13 wherein the interactive display of the destination computing device provides a filter tool displayed on the user interface to receive a request to filter the transaction activity information according to certain selected characteristics for the plurality of users, and thereby re-generate, a new value for the sentiment index based on the selected characteristics.

15. The method of claim 13 wherein the proxy components used to represent the sentiment index are eliminated if their weighting coefficient is negligible from applying the principal component analysis.

16. The method of claim 15 wherein the value of the sentiment index is calculated and communicated for display on the interactive display as a function of time from the past time period to the current time period.

17. The method of claim 16 wherein the sentiment index is based on a machine learning model of the weighted sum and/or difference of the set of proxy components and the machine learning model including the set of proxy components is modified dynamically based on the transaction activity information gathered at a subsequent time.

18. The method of claim 12 wherein the set of proxy components is selected from one or more of: volatility of shares traded by investors, a ratio between put and call options, a ratio of buy orders to sell orders, a number of new trading accounts in a time window, a ratio between short and long investment positions, portion of trades on shares with a positive price direction, an average return on assets held by investors over a time window, an average margin loan taken by investors, a volume transferred in and out of funds, allocation across fund categories, ratio of share bough in annual highs vs annual lows.

19. The method of claim 13, wherein a positive sentiment index indicates a bullish trend towards performing transactions and a negative sentiment index indicates a bearish trend towards performing transactions.

20. The method of claim 13, wherein the set of proxy components selected provide an indicator of greed, demand, fear and herding for characterizing the actual transaction activity information.

21. The method of claim 12, wherein determining the set of proxy components to represent the transaction activity information based on types of transactions in the transaction activity information further comprises classifying types of transactions as similar to prior types of transactions having associated set of proxy components used to evaluate a corresponding sentiment index.

22. The method of claim 12, wherein determining the set of proxy components further comprises determining one or more characteristics of users when performing the transactions and retrieving a corresponding set of proxy components previously associated with the characteristics of the users.

23. A computer program product comprising a non-transient storage device storing instructions that when executed by at least one processor of a computing device, configure the computing device for determining a sentiment index for a plurality of transactions, the computing device configured to:
track and receive real-time actual transaction activity information detailing each transaction performed over a past time period to a current time for each user from a plurality of users associated with an entity;
determine a set of proxy components to represent the transaction activity information based on types of the transactions in the transaction activity information;
generate the sentiment index having a value representing market sentiment for confidence at the current time in performing the transactions based on a weighted sum and/or difference of the set of proxy components, the weighting determined from applying principal component analysis to the transaction activity information to define a best fitting estimate that minimizes error between the estimate to the transaction activity information; and
communicate the value of the sentiment index to a destination computing device for display on an interactive display of a user interface for subsequent use in performing further transactions.
